(19) United States
(12) Patent Application Publication
(10) Pub. No.: US 2007/0106700 A1
(43) Pub. Date: May 10, 2007

(54) Hierarchical file system naming

(75) Inventors: Matthew A. Ahrens, San Francisco, CA (US); Mark J. Maybee, Boulder, CO (US); Jeffrey S. Bonwick, Los Altos, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/416,745

(22) Filed: May 3, 2006

Related U.S. Application Data
(60) Provisional application No. 60/733,933, filed on Nov. 4, 2005.

(51) Int. Cl. G06F 17/30

(52) U.S. Cl. 707/200

(57) ABSTRACT

A storage pool including a file system, where the file system is associated with a name and the name is determined using a hierarchical data structure.

### CROSS REFERENCE TO RELATED APPLICATIONS

This application claims benefit of U.S. Provisional Application Ser. No. 60/733,933 filed on Nov. 4, 2005, entitled “Hierarchical File System Naming and Inheritable File System Properties” in the names of Matthew A. Ahrens, Mark J. Maybee, and Jeffrey S. Bonwick, and is hereby incorporated by reference.

The present application contains subject matter that may be related to the subject matter in the following U.S. patent applications, which are all assigned to a common assignee: “Inheritable File System Properties” (Attorney Docket No. 03226/773001; SUN060283).

### BACKGROUND

Each computer is typically associated with a file system for organizing and maintaining files stored (permanently or temporarily) in the computer. Prior to using a file system, the file system must first be mounted onto a mount point. Mounting a file system corresponds to instructing the operating system, which is executing on the computer, to make the file system available to a user of the computer at a specified location (i.e., the mount point).

Once the file system has been created, it is typically only identifiable by the raw device name (i.e., the file name corresponding to the physical storage medium) upon which it was created, for example: /dev/dsk/c0t0d0s0. The file system may be subsequently bound, temporarily, to a name via a mount, where the name corresponds to the path of the chosen mount point, for example, /export/home. However, the aforementioned temporary name binding only lasts for the duration of the mount. Thus, once the file system is unmounted, the temporary naming binding ceases to exists.

In some instances, the temporary name binding may persist by storing the device-to-mount-point association. For example, the Unix File System (UFS) maintains a /etc/vfstab file, where each entry in the aforementioned file includes, among other information, the following information: (i) a device to mount and (ii) mount point. Using the example above, one entry in the aforementioned file would include /dev/dsk/c0t0d0s0 and /export/home.

### SUMMARY

In general, in one aspect, the invention relates to a storage pool, comprising a file system, wherein the file system is associated with a name and the name is determined using a hierarchical data structure.

In general, in one aspect, the invention relates to a method for naming a file system, comprising determining a node corresponding to the file system in a hierarchical data structure, determining a node corresponding to a storage pool in the hierarchical data structure, tracing a path from the node corresponding to the storage pool to the node corresponding to the file system, wherein the path corresponds to a name of the file system.

In general, in one aspect, the invention relates to a computer readable medium comprising computer executable instructions to: determine a node corresponding to a file system in a hierarchical data structure, determine a node corresponding to a storage pool in the hierarchical data structure, trace a path from the node corresponding to the storage pool to the node corresponding to the file system, wherein the path corresponds to a name of the file system.

Other aspects of the invention will be apparent from the following description and the appended claims.

### BRIEF DESCRIPTION OF DRAWINGS

FIG. 1 shows a block diagram of a storage pool in accordance with an embodiment of the invention.

FIG. 2 shows a block diagram of a hierarchical data structure in accordance with one embodiment of the invention.

FIG. 3 shows a flowchart in accordance with one embodiment of the invention.

FIG. 4 shows a computer system in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of one or more embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention relate to a method and system for naming a file system. More specifically, embodiments of the invention relate to a method and system for using a hierarchical data structure to name a file system.

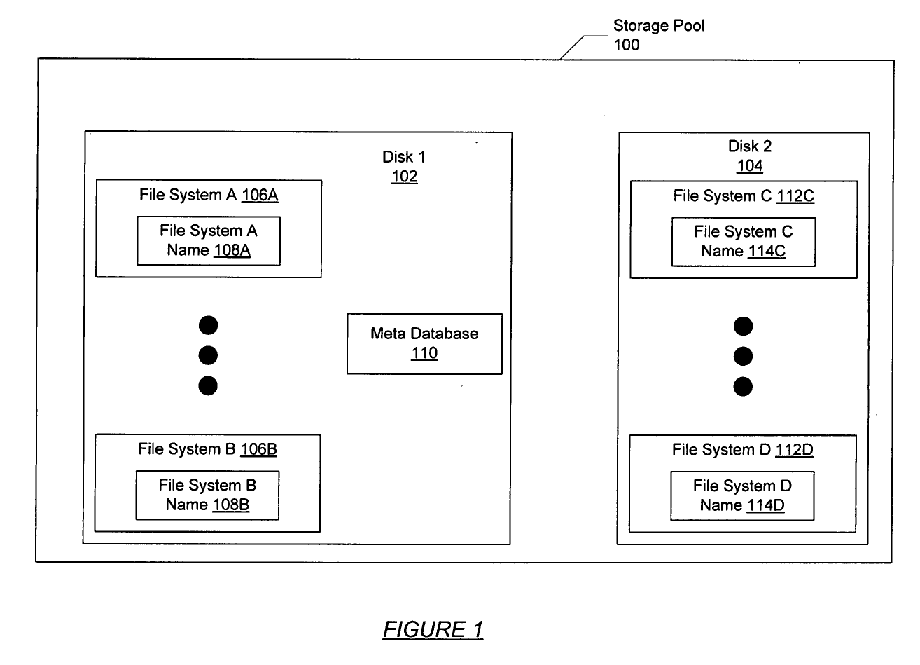

FIG. 1 shows a block diagram of a storage pool in accordance with an embodiment of the invention. As shown in FIG. 1, the storage pool (100) includes two disks: disk 1 (102) and disk 2 (104). Those skilled in the art will appreciate that the storage pool (100) may include more than two disks. Further, each disk (102, 104) may include one or more file systems (e.g., File System A (106A), File System B (106B), File System C (112C), File System D (112D)). In addition, each file system (106A, 106B, 112C,1 12D) in the storage pool (100) is associated with a name (e.g., File System A Name (108A), File System B Name (108B), File System C Name (114C), File System D Name (114D)), where the name associated with the file system is independent from the disk upon which it is located or mounted. In one embodiment of the invention, the name of each file system is maintained in a meta database (110).

Those skilled in the art will appreciate that each of the aforementioned file systems (e.g., File System A (106A), File System B (106B), File System C (112C), File System D (112D)) may be distributed across all disks (e.g., disk 1 (102) and disk 2 (104)) in the storage pool. Said another way, the data (e.g., files and metadata) associated with a given file system may be stored across multiple disks in the storage pool. For example, some data associated with file system A (106A) may be stored on disk 1 (102) while other data associated with file system A (106A) may be stored on disk 2 (104).

In one embodiment of the invention, the meta database (110) may correspond to any data structure that is configured to store the names (108A, 108B, 112C, 112D) of the file systems in the storage pool (100). Further, the meta database (110) may also include information about properties associated with each of the file systems (106A, 106B, 112C, 112D). The meta database (110) may be stored on any disk (e.g., disk 1, disk 2) in the storage pool (100).

In one embodiment of the invention, each file system is named using the following naming convention: name=[storage pool name]/([Container Name]*/[File System Name]*)*. Using the aforementioned naming convention, each file system name includes at least the storage pool name (e.g., the name of the storage pool in which the file is located) as well as the specific name of the file system in the storage pool. In addition, the name may also reference additional file systems and/or containers (defined below).

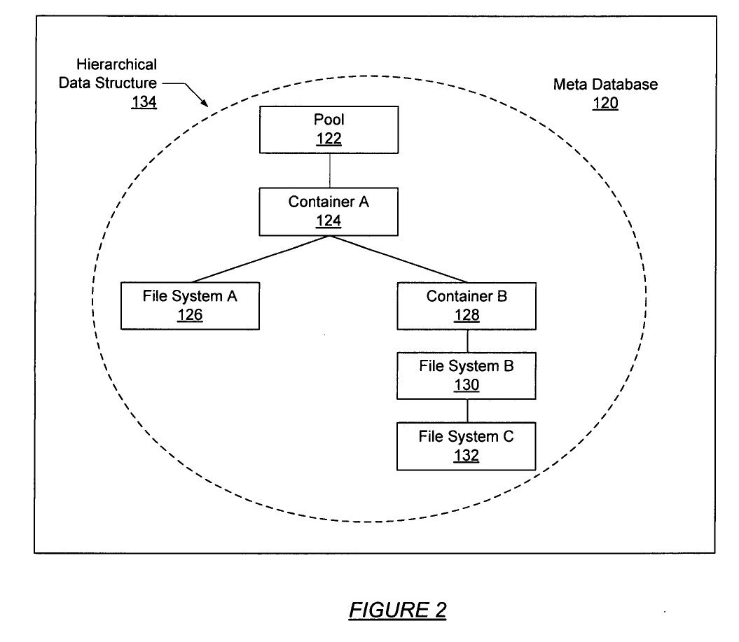

FIG. 2 shows a block diagram of a hierarchical data structure in accordance with one embodiment of the invention. More specifically, FIG. 2 shows a hierarchical data structure (134) located in a meta database (120), in accordance with one embodiment of the invention. In one embodiment of the invention, the meta database (120) includes a hierarchical data structure (134) in which each node in the hierarchical data structure correspond to one of the following : (i) a storage pool; (ii) a container; or (iii) a file system. In one embodiment of the invention, the container corresponds to a file system that is not a leaf in the hierarchical data structure. For example, as shown in FIG. 2, the node corresponding to container A (124) conceptually includes the node corresponding to file system A (126) and the node corresponding to container B (128). Further, the node corresponding to container B (128) conceptually includes the node corresponding to file system B (130) and the node corresponding to file system C (132).

In one embodiment of the invention, the name of a file system is determined by tracing a path from the node corresponding to the storage pool to the node corresponding to the file system. With respect to file system A (126), the name for file system A (126) is determined by tracing the path from the node corresponding to the storage pool (122) through the node corresponding to container A (124) and terminating at the node corresponding to file system A (126). Thus, the name for file system A (126) is storage pool/container A/file system A. Similarly, the name for file system B (130) is determined by tracing the path starting at the node corresponding to the storage pool (122), through the node corresponding to container A (126), the node corresponding to container B (128), and eventually terminating at the node corresponding to file system B (130). Thus, the name for file system B (130) is storage pool/container A/container B/file system B. Finally, the name for file system C (132) is determined using the same steps as file system B (130) but terminates at the node corresponding to file system C (132). Accordingly, the name for file system C (132) is storage pool/container A/container B/file system B/ file system C.

Those skilled in the art will appreciate that any data structure, not just the hierarchical data shown in FIG. 2 may be used to maintain the names of the file systems in the storage pool. Further, those skilled in the art will appreciate that additional containers and file systems may be added to or removed from the meta database at any time.

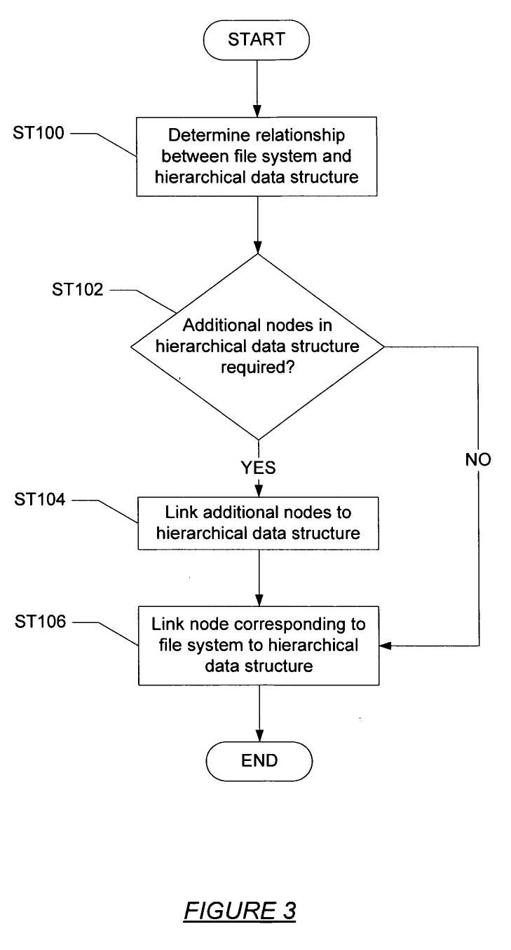

FIG. 3 shows a flow chart in accordance with one embodiment of the invention. More specifically, FIG. 3 shows a method for adding a node to a hierarchical data structure. Alternatively, the method shown in FIG. 3 may also be used to modify the relationships between various nodes in the storage pool. Turning to FIG. 3, initially, a determination is made about the relationship between the file system, which is to be added to the storage pool or renamed, and the hierarchical data structure (ST100). In one embodiment of the invention, determining the relationship corresponds to determining where the node corresponds to the file system (i.e., the file system to be added or renamed) is to be located within the hierarchical data structure. Said another way, ST100 corresponds to determining the node in the hierarchical data structure to which the node corresponding to the file system is to be link.

Once this determination has been made, a determination is made about whether the relationship determined in ST100 requires the linking additional nodes to the hierarchical data structure prior to linking the node corresponding to the file system to the data structure (ST102). For example, if the file system B is to be linked to container B, then a determination must be made about whether container B is present in the hierarchical data structure.

If additional nodes are required, then the additional nodes are linked to the hierarchical data structure (ST104). Those skilled in the art will appreciate the “linking” corresponds to associating two nodes with one another, such that the nodes, once linked, for part of the hierarchical data structure. Those skilled in the art will appreciate that any data structure may be used to “link” two nodes together.

Returning to FIG. 3, once the additional nodes are linked to the hierarchical data structure (ST104) or if no additional nodes are required (ST106), then the node corresponding to the file system is linked to the hierarchical data structure (ST106). Once the node corresponding to the file system is linked to the hierarchical data structure, the file system name may be determined, as discussed above, by following a path from the node corresponding to the storage pool to the node corresponding to the file system.

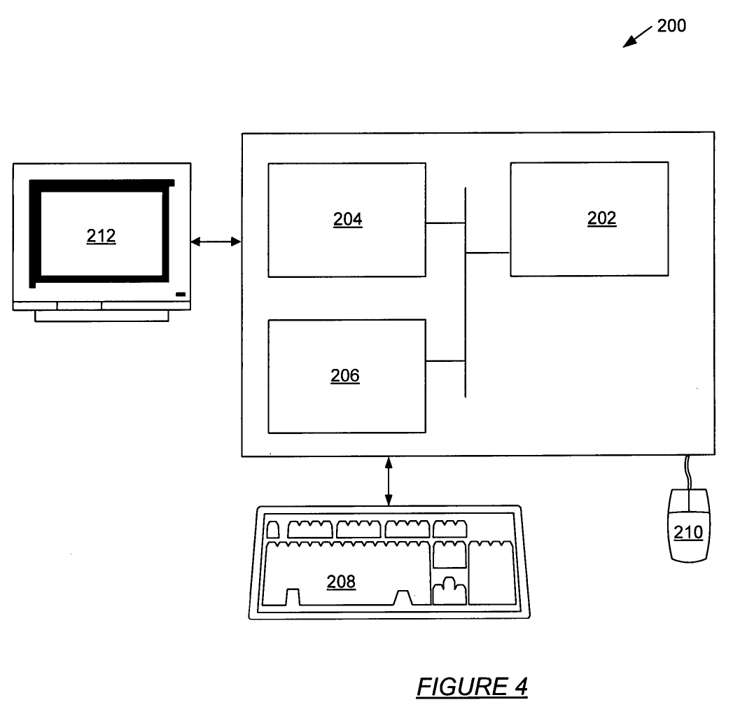

The invention may be implemented on virtually any type of computer regardless of the platform being used. For example, as shown in FIG. 4, a networked computer system (200) includes a processor (202), associated memory (204), a storage device (206), and numerous other elements and functionalities typical of today's computers (not shown). The networked computer (200) may also include input means, such as a keyboard (208) and a mouse (210), and output means, such as a monitor (212). The networked computer system (200) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer (200) may be located at a remote location and connected to the other elements over a network. Further, the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory.

Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A storage pool, comprising:
a file system, wherein the file system is associated with a name and the name is determined using a hierarchical data structure.

2. The storage pool of claim 1, further comprising:
a meta database configured to store the hierarchical data structure.

3. The storage pool of claim 2, wherein the file system is stored on a first disk and the meta database is stored on a second disk, wherein the first disk and the second disk are located in the storage pool.

4. The storage pool of claim 1, wherein the hierarchical data structure comprises a plurality of nodes, wherein each of the plurality of nodes corresponds to one selected from the group consisting of the file system, a container, and the storage pool.

5. The storage pool of claim 1, wherein the name is independent of a mount point of the file system.

6. The storage pool of claim 5, wherein the name of the file system is determined by tracing a path from the one of the plurality of nodes corresponding to the storage pool to one of the plurality of nodes corresponding to the file system.

7. The storage pool of claim 1, wherein the name complies with a naming convention comprising name=[storage pool name]/([container name]*/[file system name]*)*.

8. A method for naming a file system, comprising:
determining a node corresponding to the file system in a hierarchical data structure;
determining a node corresponding to a storage pool in the hierarchical data structure;
tracing a path from the node corresponding to the storage pool to the node corresponding to the file system, wherein the path corresponds to a name of the file system.

9. The method of claim 8, wherein the name is independent of a mount point of the file system.

10. The method of claim 8, wherein the name complies with a naming convention comprising name=[storage pool name]/([container name]*/[file system name]*)*.

11. The method of claim 8, wherein the storage pool comprises a plurality of disks.

12. The method of claim 11, wherein the hierarchical data structure is stored in a meta database.

13. The method of claim 12, wherein the file system is located on a first one of the plurality of disks and the meta database is located on a second one of the plurality of disks, wherein the first one of the plurality of disks and the second one of the plurality of disks are located in the storage pool.

14. A computer readable medium comprising computer executable instructions to:
determine a node corresponding to a file system in a hierarchical data structure;
determine a node corresponding to a storage pool in the hierarchical data structure;
trace a path from the node corresponding to the storage pool to the node corresponding to the file system, wherein the path corresponds to a name of the file system.

15. The computer readable medium of claim 14, wherein the name is independent of a mount point of the file system.

16. The computer readable medium of claim 14, wherein the name complies with a naming convention comprising name=[storage pool name]/([container name]*/[file system name]*)*.

17. The computer readable medium of claim 14, wherein the storage pool comprises a plurality of disks.

18. The computer readable medium of claim 17, wherein the hierarchical data structure is stored in a meta database.

19. The computer readable medium of claim 18, wherein the file system is located on a first one of the plurality of disks and the meta database is located on a second one of the plurality of disks, wherein the first one of the plurality of disks and the second one of the plurality of disks are located in the storage pool.
